(19) United States
(12) Patent Application Publication
(10) Pub. No.: US 2006/0091721 A1
(43) Pub. Date: May 4, 2006

(54) Torsion beam suspension system for automobiles and method of manufacturing the same

(76) Inventors: Sung-Wook Han, Busan Metropolitan City (KR); Jong-Hun Park, Guri-si (KR); Duk-Woo Nam, Ulsan Metropolitan City (KR)

Correspondence Address: DICKSTEIN SHAPIRO MORIN & OSHINSKY LLP, 2101 L Street, NW, Washington, DC, 20037, US

(21) Appl. No.: 11/133,219

(22) Filed: May 20, 2005

(30) Foreign Application Priority Data
Oct. 28, 2004 (KR) 10-2004-0086668

(51) Int. Cl. B60B 35/00

(52) U.S. Cl. 301/132

(57) ABSTRACT

Disclosed herein is a torsion beam suspension system for automobiles and a method of manufacturing the same. In the present invention, a wheel is coupled to a spindle bracket such that the center of the spindle bracket is placed in front of the center of the wheel, so that, when the spindle bracket is bent by a lateral force applied to the automobile, the toe angle of the wheel varies such that a toe-in occurs. This toe-in motion of the wheel can prevent the wheel from being toed-out due to a lateral force when the automobile turns. Therefore, the present invention prevents the automobile from oversteering when turning, thus enhancing the steering stability of the automobile.

### BACKGROUND OF THE INVENTION

1. Field of the Invention

The present invention relates generally to torsion beam suspension systems for automobiles and methods of manufacturing the same and, more particularly, to a torsion beam suspension system for automobiles which enhances the steering stability of an automobile when turning, and a method of manufacturing the same.

2. Description of the Related Art

As well known to those skilled in the art, suspension systems for automobiles are devices that couple wheels to the automobile bodies. Suspension systems absorb impact and vibration transferred from a road surface while automobiles are in motion, thus enhancing the riding comfort and stability of the automobiles.

Such a suspension system is classified into a single body type suspension system, in which left and right wheels are integrally coupled to each other through an automobile axle, and an independent type suspension system, in which left and right wheels are independently operated. Conventional suspension systems include a spring to absorb shocks transferred from a road surface and a shock absorber that prevents free vibration of the spring, thus enhancing riding comfort, and an arm or link to control the operation of the wheels.

In addition, there is a torsion beam suspension system, which is a unique hybrid of a single body type and an independent type. In the torsion beam suspension system, left and right trailing arms are coupled to each other by one unit that is called a torsion beam. The torsion beam suspension system is characterized in that the length of a link is longer than that of a strut suspension system and that of a double wishbone suspension system, and the number of bushings that may become an oscillating shaft is lower than that of the strut suspension system and that of the double wishbone suspension system.

Furthermore, the torsion beam suspension system can reduce friction hysteresis during movement of the suspension and provide a smooth comfortable ride. In addition, because it has a simple structure and a reduced number of elements, a high level of expertise is not required when designing the system, and the manufacturing costs and weight are reduced. As well, superior stability in driving the automobile is ensured. Therefore, conventional torsion beam suspensions have been used as rear suspension systems of small automobiles for many years.

As shown in FIG. 1, in such a torsion beam suspension system, a pair of trailing arms 1 and 1′ is coupled to each other by a torsion beam 2. A pair of joints 3 and 3′, each having a bushing, is provided on front ends of the trailing arms 1 and 1′, respectively. The front end of each trailing arm 1, 1′ is pivotably mounted to an automobile body (not shown) through each joint 30, 30′.

Furthermore, a spindle bracket 4, 4′ is welded to the rear end of each trailing arm 1, 1′. A wheel 5, 5′ is coupled to each spindle bracket 4, 4′.

As shown in FIG. 2, a plurality of coupling holes 4-1, 4-2, 4-3 and 4-4 is formed in each spindle bracket 4, 4′. Each wheel 5, 5′ is coupled to a respective spindle bracket 4, 4′ by a plurality of locking bolts which are tightened into the coupling holes 4-1, 4-2, 4-3 and 4-4 formed in each spindle bracket 4, 4′. Two bent parts 4a and 4b extend from opposite sides of each spindle bracket 4, 4′ in a direction perpendicular to the spindle bracket 4, 4′, thus reinforcing the spindle bracket 4, 4′.

Moreover, a suspension spring 6, 6′ is provided between the automobile body and each trailing arm 1, 1′. A shock absorber 7, 7′ is provided on the rear end of each trailing arm 1, 1′ at a position spaced apart from each spindle bracket 4, 4′ by a predetermined distance.

In the torsion beam suspension system having the above-mentioned construction, the toe angle of each wheel 5, 5′ varies during wheel bump and during wheel rebound.

Generally, during wheel bump, as shown in FIG. 3a, the toe angle dT of each wheel 5, 5′ has a negative value (−), that is, the wheels 5 and 5′ have toe-in orientation. During wheel rebound, as shown in FIG. 3b, the toe angle dT of each wheel 5, 5′ has a positive value (+), that is, the wheels 5 and 5′ have toe-out orientation.

Typically, the initial value of the toe angle dT has a positive value (+) within an appropriate range. In the case of a rear suspension system, to induce an understeer, the suspension system is set such that the toe angle dT assumes a toe-in value when lateral force is applied to an automobile.

However, in conventional torsion beam suspension systems, because front ends of two trailing arms are pivotably fastened to an automobile body, when the automobile body turns, moment occurs at the trailing arms due to lateral force.

Such moment occurring due to a lateral force causes a toe-out of the toe angle of the rear wheels of the automobile. Therefore, the automobile enters an oversteer state. As such, conventional torsion beam suspension systems are problematic in that a steering stability of an automobile, when turning, is markedly reduced.

### SUMMARY OF THE INVENTION

Accordingly, the present invention has been made keeping in mind the above problems occurring in the prior art, and an object of the present invention is to provide a torsion beam suspension system for an automobile which prevents the toe angle of the wheels of the automobile from being toed-out due to a lateral force when the automobile turns, thus enhancing the steering stability of the automobile when turning.

In one aspect, the present invention provides a torsion beam suspension system for an automobile, including: a spindle bracket to which a wheel is coupled such that a center of the spindle bracket is placed frontward of a center of the wheel on a longitudinal axis of the automobile by a predetermined offset distance.

The spindle bracket may include an extension part which extends forwards from the spindle bracket by a width the same as the offset distance that is defined between the center of the spindle bracket and the center of the wheel, thereby allowing the center of the spindle bracket to be placed in front of the center of the wheel by the offset distance.

In another aspect, the present invention provides a method of manufacturing a torsion beam suspension system for an automobile, including: coupling a wheel to a spindle bracket such that a center of the spindle bracket is placed frontward of a center of the wheel on a longitudinal axis of the automobile by a predetermined offset distance.

The coupling of the wheel to the spindle bracket may includes providing an extension part which extends frontward from the spindle bracket by a width the same as the offset distance that is defined between the center of the spindle bracket and the center of the wheel, thereby allowing the center of the spindle bracket to be placed in front of the center of the wheel by the offset distance.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing a conventional torsion beam suspension system;

FIG. 2 is a front view showing a spindle bracket of the torsion beam suspension system of FIG. 1;

FIGS. 3a and 3b are views illustrating a toe-in angle and toe-out angle of a wheel of an automobile;

FIG. 4 is a perspective view of a torsion beam suspension system for automobiles, according to a preferred embodiment of the present invention;

FIG. 5 is a front view showing a spindle bracket of the torsion beam suspension system of FIG. 2;

FIG. 6a is a view illustrating the characteristics of the torsion beam suspension system of FIG. 5 when the center of the spindle bracket is not offset from the center of a wheel;

FIG. 6b is a view illustrating the characteristics of the torsion beam suspension system of FIG. 5 when the center of the spindle bracket is offset from the center of the wheel; and

FIG. 7 is a graph showing compliance steer as a function of lateral force when offset is applied and when offset is not applied.

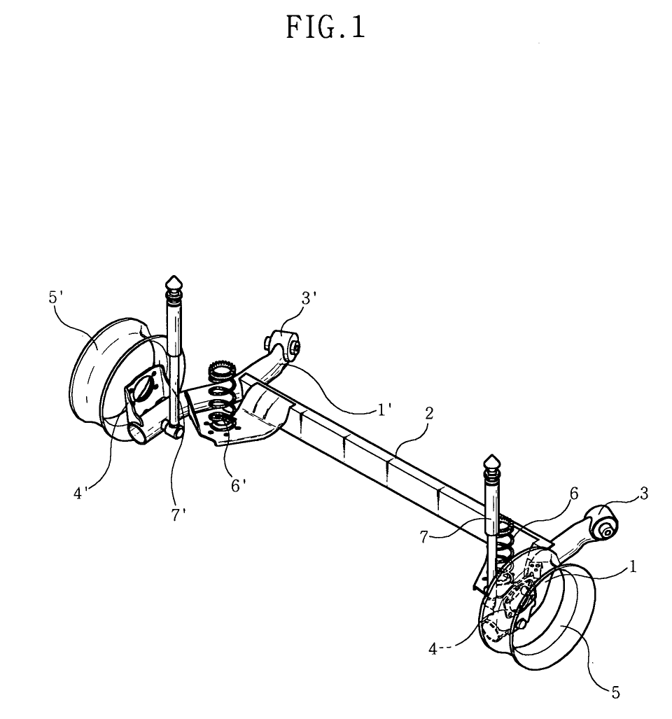

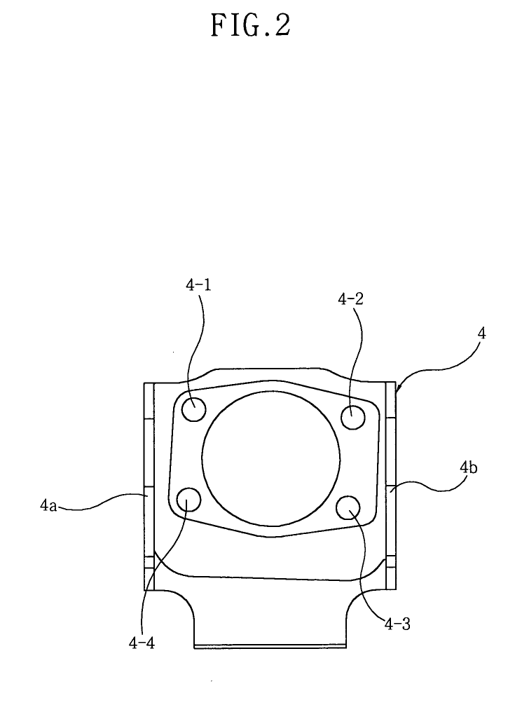

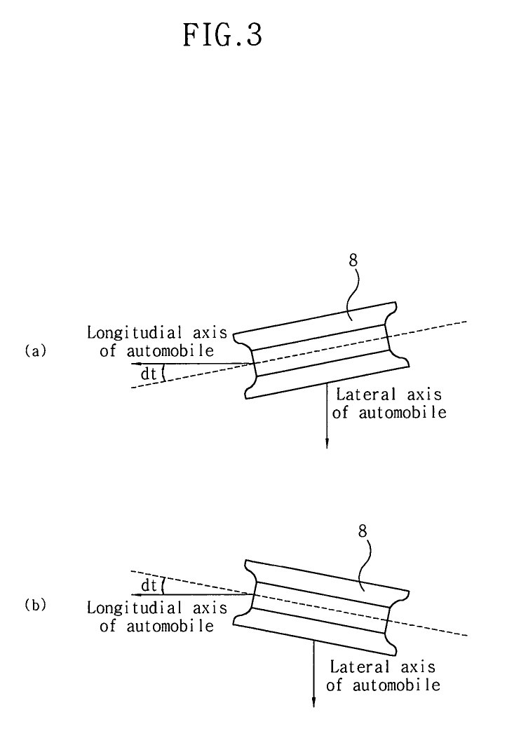

### DESCRIPTION OF THE PREFERRED EMBODIMENTS

Reference now should be made to the drawings, in which the same reference numerals are used throughout the different drawings to designate the same or similar components.

Hereinafter, a preferred embodiment of the present invention will be explained in detail with reference to the attached drawings.

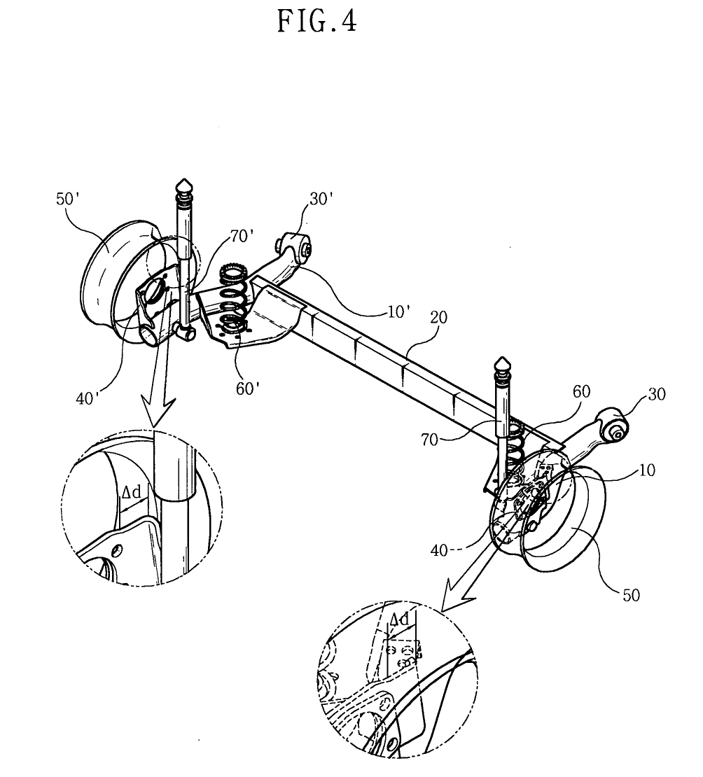

FIG. 4 is a perspective view of a torsion beam suspension system for automobiles, according to a preferred embodiment of the present invention. As shown in FIG. 4, in the torsion beam suspension system of the present invention, two trailing arms 10 and 10′ are coupled to each other by a torsion beam 20. Two joints 30 and 30′, each having a bushing, are provided on front ends of the trailing arms 10 and 10′, respectively. The front end of each trailing arm 10, 10′ is pivotably mounted to an automobile body (not shown) through each joint 30, 30′.

Furthermore, a spindle bracket 40, 40′ is welded to a rear end of each trailing arm 10, 10′. A wheel 50, 50′ is coupled to each spindle bracket 40, 40′.

Moreover, a suspension spring 60, 60′ is provided between the automobile body and each trailing arm 10, 10′. A shock absorber 70, 70′ is provided on the rear end of each trailing arm 10, 10′ at a position spaced apart from each spindle bracket 40, 40′ by a predetermined distance.

In the preferred embodiment, the elements provided on opposite first and second ends of the torsion beam 20 have the same structure. Therefore, for ease of description, only the elements that are provided on the first end of the torsion beam 20 will be explained herein below.

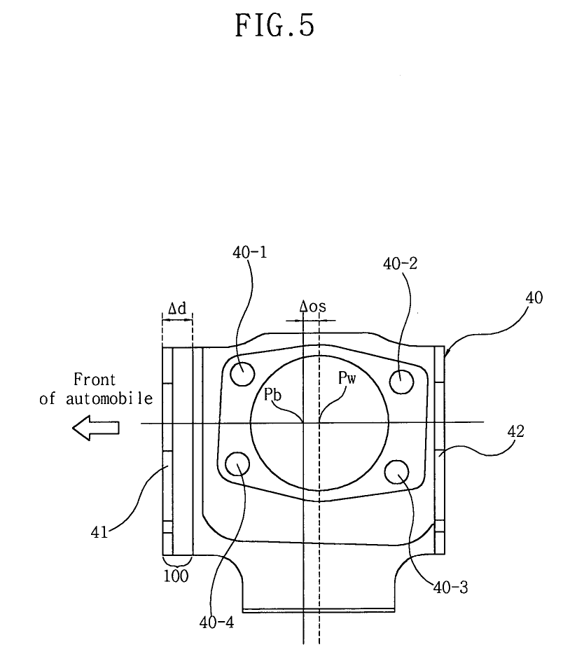

As shown in FIG. 5, a plurality of coupling holes 40-1, 40-2, 40-3 and 40-4 is formed in the spindle bracket 40. The wheel 50 is coupled to the spindle bracket 40 by a plurality of locking bolts, which are tightened into the coupling holes 40-1, 40-2, 40-3 and 40-4. Two bent parts 41 and 42 extend from opposite sides of the spindle bracket 40 in a direction perpendicular to the spindle bracket 40, thus reinforcing the spindle bracket 40.

Furthermore, the spindle bracket 40 includes an extension part 100 which extends forward from the spindle bracket 40 by a desired width Ad such that the center Pb of the spindle bracket 40 is placed in front of the center Pw of the wheel 50 by an offset distance ΔOS the same as the desired width Δd.

Here, both the center Pb of the spindle bracket 40 and the center Pw of the wheel 50 are defined relative to the longitudinal axis of the automobile.

The operation and effect of the present invention having the above-mentioned structure will be described in detail with reference to the attached drawings.

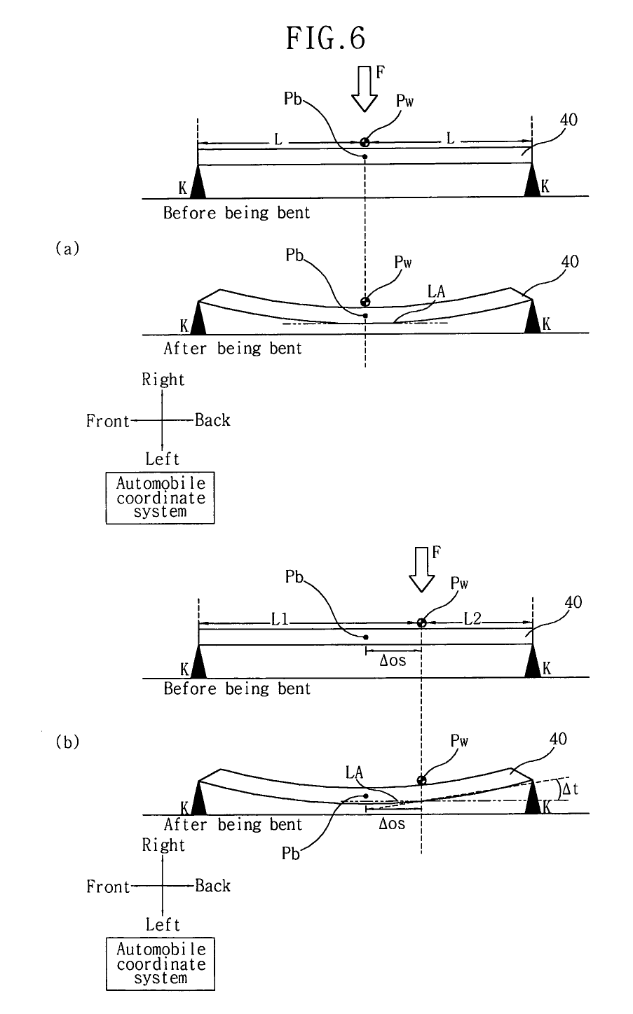

First, FIG. 6a is a view illustrating the characteristics of the torsion beam suspension system when the center Pb of the spindle bracket 40 is not offset from the center Pw of the wheel 50. In FIG. 6a, the spindle bracket 40 has been simplified to have a beam shape for convenience of description.

As shown in FIG. 6a, if a leftward lateral force F is applied to both the spindle bracket and the wheel 50, the spindle bracket 40 is elastically bent, so that the intermediate portion of the spindle bracket 40 is moved in a direction opposite from the orientation of the lateral force F.

At this time, in the case that the offset ΔOS is not applied to the centers of the spindle bracket 40 and the wheel 50, the center Pb of the spindle bracket 40 and the center Pw of the wheel 50 are at the same position. Therefore, curvature of the position of the spindle bracket 40 on which the wheel 50 is mounted does not vary regardless of the bend of the spindle bracket 40. Thus, the toe angle of the wheel 50 is also not changed with respect to the longitudinal axis of the automobile.

However, referring to FIG. 6b, in the case that the center Pb of the spindle bracket 40 is offset from the center Pw of the wheel 50, that is, in the case that the center Pw of the wheel 50 is placed rearward of the center Pb of the bracket 40, when a lateral force F is applied to both the spindle bracket 40 and the wheel 50, curvature of the position of the spindle bracket 40 on which the wheel 50 is mounted varies while the spindle bracket 40 is bent.

Here, according to a variation of the curvature of the central portion of the wheel 50, the toe angle variation Δt of the wheel 50 with respect to the longitudinal axis of the automobile also varies. As shown in FIG. 6b, in this case, the toe angle variation Δt causes a toe-in having a negative value (−).

As such, the toe-in of the wheel 50 that is induced by the offset ΔOS applied to the centers of the spindle bracket 40 and the wheel 50 prevents the wheel 50 from being toed-out due to a lateral force when the automobile turns. Therefore, in the present invention, oversteer of the automobile is minimized, thereby enhancing the steering stability of the automobile, when turning.

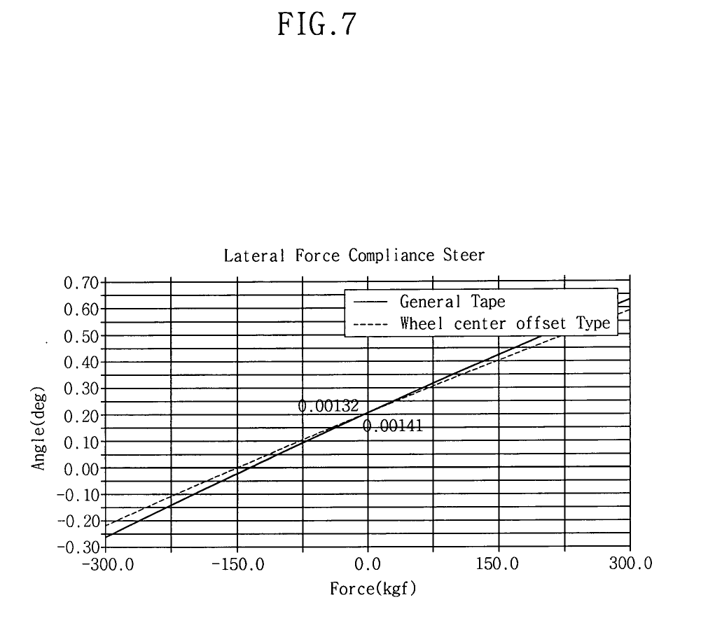

For reference, FIG. 7 is a graph showing compliance steer as a function of lateral force when the offset ΔOS is applied to the centers of the spindle bracket 40 and the wheel 50 (this case is shown as a solid line) and when the offset ΔOS is not applied (this case is shown as a dotted line).

As described above, the present invention provides a torsion beam suspension system for an automobile in which a wheel is coupled to a spindle bracket such that the center of the spindle bracket is placed in front of the center of the wheel, so that, when the spindle bracket is bent by a lateral force applied to the automobile, the toe angle of the wheel is varied such that a toe-in occurs. This toe-in of the wheel prevents the wheel from being toed-out due to a lateral force when the automobile turns. Therefore, the present invention prevents the automobile from oversteering when turning, thus enhancing the steering stability of the automobile.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A torsion beam suspension system for an automobile, comprising:
a spindle bracket to which a wheel is coupled such that a center of the spindle bracket is placed frontward of a center of the wheel on a longitudinal axis of the automobile by a predetermined offset distance.

2. The torsion beam suspension system as set forth in claim 1, wherein the spindle bracket comprises an extension part which extends forward from the spindle bracket by a width the same as the offset distance that is defined between the center of the spindle bracket and the center of the wheel, thereby allowing the center of the spindle bracket to be placed in front of the center of the wheel by the offset distance.

3. A method of manufacturing a torsion beam suspension system for an automobile, comprising:
coupling a wheel to a spindle bracket such that a center of the spindle bracket is placed frontward of a center of the wheel on a longitudinal axis of the automobile by a predetermined offset distance.

4. The method as set forth in claim 3, wherein the coupling of the wheel to the spindle bracket comprises:
providing an extension part which extends frontward from the spindle bracket by a width the same as the offset distance that is defined between the center of the spindle bracket and the center of the wheel, thereby allowing the center of the spindle bracket to be placed in front of the center of the wheel by the offset distance.
